(19) United States
(12) Patent Application Publication
(10) Pub. No.: US 2007/0221876 A1
(43) Pub. Date: Sep. 27, 2007

(54) Systems and method of manufacturing a firefighting composition

(75) Inventors: George W. Bladh, Sacramento, CA (US); Donald J. Neverkovec, Orangevale, CA (US)

Correspondence Address: Gerald M. Bluhm, 50 Technology Drive, Westminster, MA, 01441, US

(73) Assignee: Ansul Canada Ltd., Toronto (CA)

(21) Appl. No.: 11/303,460

(22) Filed: Dec. 15, 2005

Related U.S. Application Data
(60) Provisional application No. 60/660,121, filed on Mar. 9, 2005.

(51) Int. Cl. A62D 1/00

(52) U.S. Cl. 252/8.05

(57) ABSTRACT

A method of producing a hydrated firefighting composition includes providing a fire fighting gel concentrate at a predetermined gel flow rate, providing a hydrating liquid at a predetermined liquid flow rate, controlling the gel flow rate and the liquid flow rate based on one another, and combining the firefighting gel concentrate and the hydrated liquid to produce a hydrated firefighting composition.

### CROSS REFERENCE TO RELATED APPLICATIONS

This application claims priority to U.S. Provisional Application Ser. No. 60/660,121, filed Mar. 9, 2005, which is hereby incorporated by reference in its entirety.

### BACKGROUND OF THE INVENTION

This invention relates generally to firefighting systems and more particularly to a method and apparatus to facilitate firefighting.

Fires can only exist if three elements are present: heat, fuel, and oxygen. In wildland firefighting, fires are extinguished by removing fuel from the fire. Generally, a fire extinguishing agent is applied from the air to coat unburned fuels on the ground with a material generically called Long Term Retardant.

At least one known Long Term Retardant includes a powdered material and/or a concentrated base material that is mixed with water to a desired consistency. The known Long Term Retardant is then stored in tanks for loading on the aircraft. The aircraft then drops the Long Term Retardant on unburned fuels in the path of an advancing wildland fire with the intent of starving the fire of fuel.

More specifically, at least one known Long Term Retardant includes a clay-based material that, when mixed with water, forms a slurry. When the clay-based Long Term Retardant is dropped from an aircraft, it coats ground fuels with a film of wet fire clay that dries very quickly. If the fire reaches the coated fuels before the Long Term Retardant dries, it is effective. However, if the clay-based Long Term Retardant dries before it coats the ground fuel, the clay-based Long Term Retardant is only marginally effective in resisting direct flame impingement.

Moreover, at least one known Long Term Retardant includes a gel concentrate, also referred to as a “water enhancer”, that absorbs water molecules and holds them in suspension inside a polymer bubble. When used as a Long Term Retardant and dropped from aircraft, the poly-drops of water attach themselves to unburned fuels. However, gel concentrates do not readily mix with water. More specifically, when known gel concentrates are mixed with water, a phenomenon called gel-block occurs, resulting in a heterogeneous mixture. Therefore, severe agitation must be instituted to complete the mixing process. The known gel-based Long Term Retardant is then stored for up to 24 hours while maximum hydration is achieved. If underhydrated gel-based Long Term Retardant is applied to wildland fires it may not perform as expected and additionally could create an environmental remediation problem.

### BRIEF DESCRIPTION OF THE INVENTION

In one aspect, a method is provided of producing a hydrated firefighting composition that comprises providing a fire fighting gel concentrate at a predetermined gel flow rate, providing a hydrating liquid at a predetermined liquid flow rate, controlling one of the gel flow rate and the liquid flow rate based on the other of the gel flow rate and the liquid flow rate, and combining the firefighting gel concentrate and the hydrated liquid to produce a hydrated firefighting composition.

In another aspect, a system is provided that includes a blending stage having an inlet and a discharge. A hydrating liquid and a gel concentrate enter the blending stage at the inlet as a heterogeneous solution and continuously flow from the inlet to the discharge without storage in the blending stage.

### BRIEF DESCRIPTION OF THE DRAWINGS

FIG. 1 is an exemplary system for producing a hydrated firefighting composition;

FIG. 2 is a schematic illustration of a mixing station;

FIG. 3 is a schematic illustration of an optional mixing station; and

FIG. 4 is a second exemplary system for producing a hydrated firefighting composition.

### DETAILED DESCRIPTION OF THE INVENTION

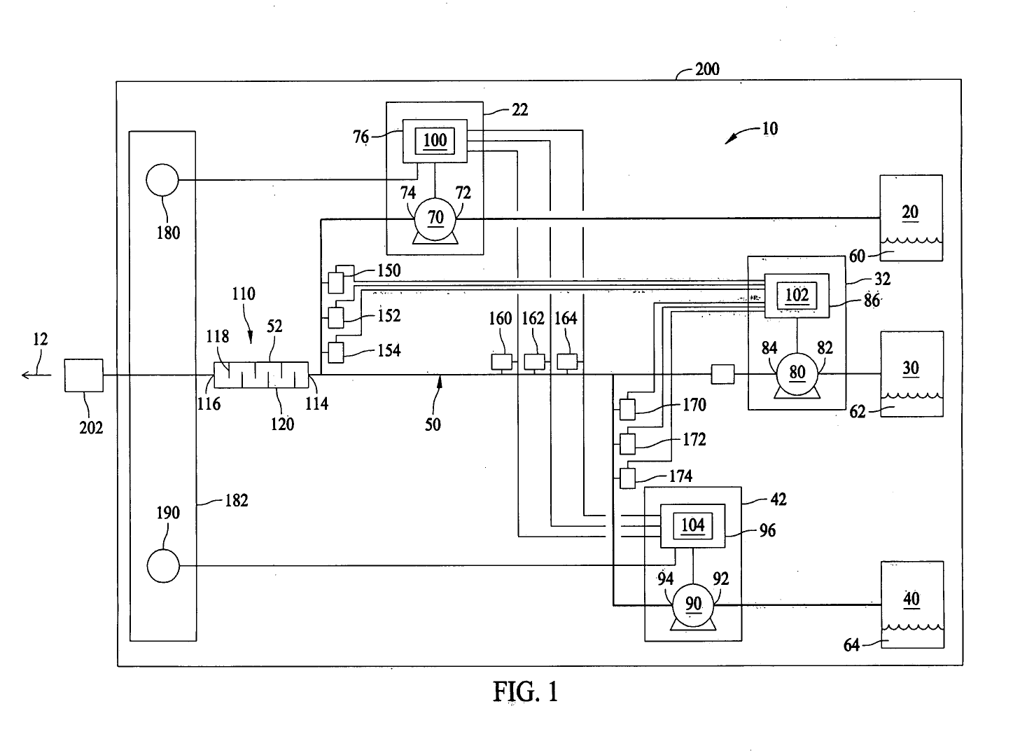

FIG. 1 is a system 10 for producing a hydrated firefighting composition 12. System 10 includes a first storage unit 20 and a first pumping module 22 coupled in flow communication with the first storage unit 20. A second pumping module 32 is coupled in flow communication with a second storage unit 30. A third pumping module 42 is coupled in flow communication with a third storage unit 40. System 10 also includes a manifold 50 that is coupled in flow communication with first pumping module 22, second pumping module 32, and third pumping module 42, respectively, and a blending and/or mixing stage 52 that is coupled in flow communication with manifold 50.

First storage unit 20 is utilized to store a predetermined quantity of firefighting gel concentrate 60, second storage unit 30 is utilized to store a predetermined quantity of a hydrating fluid 62, and third storage unit 40 is utilized to store a predetermined quantity of colorant 64.

First pumping module 22 includes a pump 70 (for example, but not limited to, a variable speed pump) having an inlet or suction side 72 that is coupled in flow communication with first storage unit 20, an outlet or discharge side 74, that is coupled in flow communication with manifold 50, and a control system 76 that may be utilized to vary the output of pump 70. The pump 70 channels firefighting gel concentrate 60 from first storage unit 20 to manifold 50.

Second pumping module 32 includes a pump 80 having an inlet or suction side 82 that is coupled in flow communication with second storage unit 30, an outlet or discharge side 84, that is coupled in flow communication with manifold 50, and a control system 86 that may be utilized to vary the output of pump 80. The pump 80 channels hydrating fluid 62 from second storage unit 30 to manifold 50.

Third pumping module 42 includes a pump 90 having an inlet, or suction side 92 that is coupled in flow communication with third storage unit 40, an outlet, or discharge side 94, that is coupled in flow communication with manifold 50, and a control system 96 that may be utilized to vary the output of pump 90. The pump 90 channels colorant 64 from third storage unit 40 to manifold 50. Although only a single colorant storage unit 40 is shown, it should be realized that system 10 may include a plurality of colorant storage units 40, each including a different colorant 64, to facilitate injecting a plurality of colorants, either simultaneously or separately, into manifold 50.

Each control system 76, 86, and 96 may include a respective computing module 100, 102, and 104, that is configured to receive at least one input and vary the output of the respective pump 70, 80 and 90 based on the received input. In the exemplary embodiment, computing modules 100, 102, and 104, are each configured to activate and/or deactivate respective pumps 70, 80, and/or 90. Optionally, the flows of water, colorant and gel may be controlled by opening, closing, and/or varying a valve, orifice, or the like. The computing modules 100, 102, and 104 execute instructions stored in firmware (not shown). Computing modules 100, 102, and 104 are each programmed to perform functions described herein. As used herein, the term computing module is not limited to just those integrated circuits referred to in the art as computers, but broadly refers to, microprocessors, microcontrollers, microcomputers, programmable logic controllers, application specific integrated circuits, and other programmable circuits, and these terms are used interchangeably herein.

System 10 also includes a mixing station 110 to facilitate mixing and/or blending materials discharged from first storage unit 20, second storage unit 30 and/or third storage unit 40 to produce a fully hydrated firefighting composition 12. More specifically, the water is encapsulated by the gel to facilitate reducing evaporation. The term “fully hydrated” as used herein is defined as when at least 85% of the hydrating liquid is encapsulated in the gel concentrate. As such, when 98% of the hydrating liquid is encapsulated in the gel concentrate, the composition is fully hydrated.

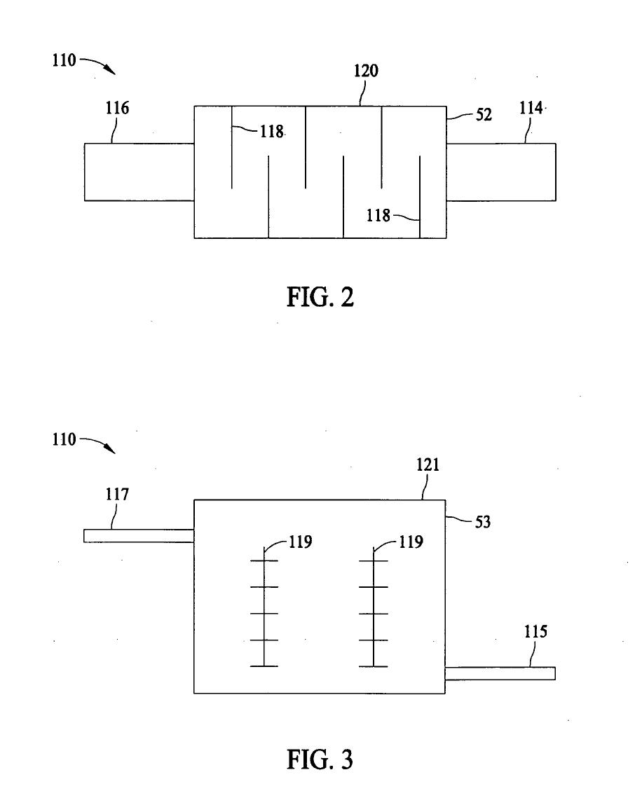

In one embodiment, shown in FIG. 2, mixing station 110 includes a static mixer 52 having an inlet 114 coupled in flow communication with manifold 50 and an outlet 116. Static mixer 52 includes a series of geometric mixing elements and/or baffles 118 that are fixed within an outer casing 120. In operation, static mixer 52 utilizes the energy of the flow stream to mix two or more fluids channeled therethrough. Although the exemplary embodiment includes a static mixer 52 to facilitate mixing the fluids channeled therethrough, it should be realized that various other devices such as a dynamic mixer, shown in FIG. 3, i.e. a spinning propeller in a hollow tube, may also be utilized to mix the various fluids.

Optionally, mixing station 110 includes a dynamic static mixer 53 shown in FIG. 3, having an inlet 15 coupled in flow communication with manifold 50 and an outlet 117. Static mixer 53 includes at least one movable mixing element 119, such as an auger for example that are coupled within an outer casing 121. In operation, static mixer 53 utilizes mixing elements 119 to mix two or more fluids channeled therethrough.

Referring again to FIG. 1, system 10 also includes a plurality of sensing elements and/or transducers to facilitate monitoring and/or controlling the flowrate and/or pressure of the materials discharged from storage units 20, 30, and 40, respectively. Specifically, a first pressure sensor 150, a first flow sensor 152, and a first temperature sensor 154 are configured to sense the pressure, flow, and temperature, respectively, of the material discharged from first pumping module 22. A second pressure sensor 160, a second flow sensor 162, and a second temperature sensor 164 are configured to sense the pressure, flow, and temperature, respectively, of the material discharged from second pumping module 32. A third pressure sensor 170, a third flow sensor 172, and a third temperature sensor 174 are configured to sense the pressure, flow, and temperature, respectively, of the material discharged from third pumping module 22.

System 10 also includes a first regulating assembly 180 that, in the exemplary embodiment, is coupled to a control panel 182. The regulating assembly 180 controls the quantity of materials discharged from first pumping module 22, Optionally, the first regulating assembly 180 may be coupled to first pumping module 22. The first regulating assembly 180 may constitute a manual valve that transmits a signal to computing module 100 to facilitate regulating the quantity of firefighting gel concentrate 60 that is discharged from first pumping module 22 into manifold 50 and then mixed with hydrating fluid 62 and/or colorant 64. In another embodiment, first regulating assembly 180 may be an electronic input device configured to receive an operator input indicative of the desired quantity of firefighting gel concentrate 60 to be discharged from first pumping module 22 into manifold 50.

A second regulating assembly 190 controls the quantity of materials discharged from third pumping module 42. The second regulating assembly 190 is coupled to control panel 182. Optionally, second regulating assembly 190 may be coupled to third pumping module 42. The second regulating assembly 190 may be a manual valve that transmits a signal to computing module 104 to facilitate regulating the quantity of colorant 64 that is discharged from third pumping module 42 into manifold 50 and then mixed with hydrating fluid 62 and/or firefighting gel concentrate 60. In another embodiment, second regulating assembly 190 may be an electronic input device configured to receive an operator input indicative of the desired quantity of colorant 64 to be discharged from third pumping module 42 into manifold 50.

A portable platform 200 is provided that permits system 10 to be transported and/or moved to various locations. For example, system 10 may be coupled to a trailer assembly such that system 10 can be transported to an aircraft, for example, wherein system 10 can operated to facilitate discharging hydrated firefighting composition 12 into the waiting aircraft. Additionally, portable platform 200 may be either permanently or temporarily installed on, or coupled to, a vehicle and driven to the aircraft.

In operation, first storage unit 20 is filled to a predetermined capacity with a firefighting gel concentrate 60. In the exemplary embodiment, firefighting gel concentrate 60 is a polymer gel concentrate such as, but not limited to, AFG Firewall™ distributed by Ansul Canada Ltd. The first storage unit 20 may be selectively sized to store several gallons of firefighting gel concentrate 60. Second storage unit 30 is filled to a predetermined capacity with a hydrating fluid 62, such as fresh water. In the exemplary embodiment, second storage unit 30 is selectively sized to store several gallons of freshwater. Third storage unit 40 is filled to a predetermined capacity with a colorant 64. In the exemplary embodiment, colorant 64 is one of a known colorant dyes that can be utilized to change the color of hydrated firefighting composition 12 from a first, or uncolored shade, to a second or colorized shade. Color enables an operator to visually observe surfaces in which hydrated firefighting composition 12 has been previously applied. As stated previously herein, colorant 64 may be selected from a wide variety of colors that are pre-selected based on the terrain in which firefighting composition 12 is to be applied.

System 10 is then transported to a receiving vehicle (not shown) and is coupled to the receiving vehicle using a hose for example. A discharge valve 202 is then opened to discharge hydrated firefighting composition 12 to the receiving vehicle.

In operation, system 10 is configurable to produce a fully hydrated firefighting composition 12 that includes a predetermined percentage of firefighting gel concentrate 60, a predetermined percentage of hydrating fluid 62, and a predetermined percentage of colorant 64. Accordingly, to operate system 10, the operator inputs a desired firefighting gel concentration setting into computing module 100. For example, the operator may select a gel concentration that, in the exemplary embodiment, is between approximately 0.5% and approximately 3.0% of the total volume of firefighting composition 12 produced by system 10. Optionally, the operator may select a gel concentration that is greater than 3% of the total volume of firefighting composition 12 produced by system 10. Additionally, the operator may select a colorant 64 concentration that, in the exemplary embodiment, is between approximately 0.1% and approximately 1.0% of the total volume of firefighting composition 12 produced by system 10. Optionally, the operator may select a colorant 64 concentration that is greater than 1% of the total volume of firefighting composition 12 produced by system 10.

After the selected concentrations of gel concentrate 60 and colorant 64 have been entered, system 10 is initialized to produce hydrated firefighting composition 12. More specifically, second pump 80 is initialized to discharge hydrating fluid 62 from storage unit 30 into manifold 50. In the exemplary embodiment, second pump 80 is configured to discharge hydrating fluid 62 into manifold 50 at approximately four hundred gallons per minute (GPM). Computing modules 100 and 104 each receive inputs from pressure sensor 160, flow sensor 162, and temperature sensor 164. Computing module 104 then energizes pump 90 to facilitate colorant 64 into manifold 50 based on either the temperature, pressure, or flowrate of hydrating fluid 62 being discharged through manifold 50. For example, if second pump 80 is discharging approximately four-hundred GPM through manifold 50, and an operator has selected a fully hydrated firefighting composition 12 that includes approximately 1.0% colorant 64 per volume produced, computing module 104 will energize pump 90 such that pump 90 discharges approximately four GPM of colorant 64 into manifold 50. Additionally, if the operator has selected a fully hydrated firefighting composition 12 that includes approximately 3.0% gel concentrate 60 per volume of fully hydrated firefighting composition 12 produced, computing module 100 will energize pump 70 such that pump 70 discharges approximately twelve GPM of gel concentrate 60 into manifold 50.

As explained previously herein, gel concentrate 60, hydrating fluid 62, and colorant 64 initially form a heterogeneous composition within manifold 50. The heterogeneous composition is then channeled through manifold 50 and into static mixer 52 wherein the heterogeneous composition is mixed and/or blended to form fully hydrated firefighting composition 12. More specifically, static mixer 52 facilitates blending or mixing the heterogeneous composition without storage within static mixer 52. Thus, the heterogeneous composition is channeled through static mixer input 114, mixed within static mixer 52 without storage, and discharged from static mixer discharge 116 as a fully blended, homogeneous firefighting composition 12 that is also fully hydrated when discharged from static mixer 52.

The term homogeneous is not limited to an ideal solution or mixture, but instead, as used throughout, is intended to include substantially homogeneous compositions. Moreover, a gel composition shall be fully hydrated so long as the viscosity of the gel composition remains, for a predetermined period of time, within a desired or operating range usable for its intended purpose. By way of example only, a gel composition shall be considered fully hydrated if the viscosity does not substantially vary by more than 15% within a six hour period, vary by more than 20% within a twelve hour period, or vary by more than 25% within a twenty-four hour period, following discharge of the gel composition from the system 10.

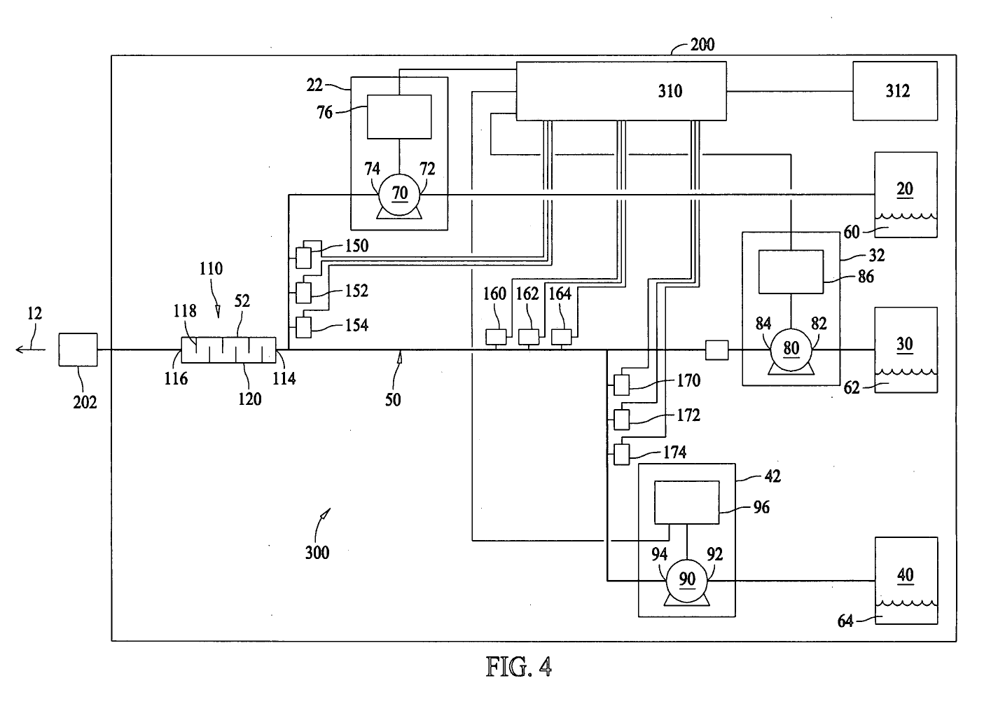

FIG. 4 is another exemplary system 300 for producing a hydrated firefighting composition 12. System 300 is substantially similar to system 10, shown in FIG. 1, and components in system 300 that are identical to components of system 10 are identified in FIG. 4 using the same reference numerals used in FIG. 1. Accordingly, system 300 includes a first storage unit 20 and first pumping module 22 coupled in flow communication with the first storage unit 20. A second pumping module 32 is coupled in flow communication with a second storage unit 30. A third pumping module 42 is coupled in flow communication with a third storage unit 40. System 300 also includes a manifold 50 that is coupled in flow communication with first pumping module 22, second pumping module 32, and third pumping module 42, respectively, and a blending and/or mixing stage 52 that is coupled in flow communication with manifold 50. First storage unit 20 is utilized to store a predetermined quantity of firefighting gel concentrate 60, second storage unit 30 is utilized to store a predetermined quantity of a hydrating fluid 62, and third storage unit 40 is utilized to store a predetermined quantity of colorant 64.

First pumping module 22 includes a pump 70 having an inlet or suction side 72 that is coupled in flow communication with first storage unit 20, an outlet or discharge side 74, that is coupled in flow communication with manifold 50, and a control system 76 that is utilized to vary the output of pump 70. The pump 70 is sized to channel firefighting gel concentrate 60 from first storage unit 20 to manifold 50.

Second pumping module 32 includes a pump 80 having an inlet or suction side 82 that is coupled in flow communication with second storage unit 30, an outlet or discharge side 84, that is coupled in flow communication with manifold 50, and a control system 86 that is utilized to vary the output of pump 80. The pump 80 is sized to channel hydrating fluid 62 from second storage unit 30 to manifold 50.

Third pumping module 42 includes a pump 90 having an inlet, or suction side 92 that is coupled in flow communication with third storage unit 40, an outlet, or discharge side 94, that is coupled in flow communication with manifold 50, and a control system 96 that is utilized to vary the output of pump 90. The pump 90 is sized to channel colorant 64 from third storage unit 40 to manifold 50. Although only a single colorant storage unit 40 is shown, it should be realized that system 300 may include a plurality of colorant storage units 40, each including a different colorant 64, to facilitate injecting a plurality of colorants, either simultaneously or separately, into manifold 50.

System 300 also includes a single computing module 310 that is configured to receive at least one input and to vary the output of at least one of pumps 70, 80 and 90 based on the received input. The computing module 310 either activates or deactivates a respective pump 70, 80, and/or 90 based on the received input from a keyboard 312, for example. Computing module 310 may execute instructions stored in firmware (not shown). Computing module 310 is programmed to perform functions described herein. As used herein, the term computing module is not limited to just those integrated circuits referred to in the art as computers, but broadly refers to, microprocessors, microcontrollers, microcomputers, programmable logic controllers, application specific integrated circuits, and other programmable circuits, and these terms are used interchangeably herein.

System 300 also includes a mixing station 110 to facilitate mixing and/or blending materials discharged from first storage unit 20, second storage unit 30 and/or third storage unit 40 to produce a fully hydrated firefighting composition 12. The mixing station 110 includes a static mixer 52 having an inlet 114 coupled in flow communication with manifold 50 and an outlet 116. Static mixer 52 includes a series of geometric mixing elements and/or baffles 118 that are fixed within an outer casing 120. In operation, static mixer 52 utilizes the energy of the flow stream to mix two or more fluids channeled therethrough.

System 300 also includes a plurality of sensing elements and/or transducers to facilitate monitoring and/or controlling the flowrate and/or pressure of the materials discharged from storage units 20, 30, and 40, respectively. Specifically, a first pressure sensor 150, a first flow sensor 152, and a first temperature sensor 154 are configured to sense the pressure, flow, and temperature, respectively, of the material discharged from first pumping module 22. A second pressure sensor 160, a second flow sensor 162, and a second temperature sensor 164 are configured to sense the pressure, flow, and temperature, respectively, of the material discharged from second pumping module 32. A third pressure sensor 170, a third flow sensor 172, and a third temperature sensor 174 are configured to sense the pressure, flow, and temperature, respectively, of the material discharged from third pumping module 22.

In operation, first storage unit 20 is filled to a predetermined capacity with a firefighting gel concentrate 60. In the exemplary embodiment, firefighting gel concentrate 60 is a polymer gel concentrate such as, but not limited to, AFG Firewall™ distributed by Ansul Canada. The first storage unit 20 may be selectively sized to store several gallons of firefighting gel concentrate 60. Second storage unit 30 is filled to a predetermined capacity with a hydrating fluid 62, such as fresh water. In the exemplary embodiment, second storage unit 30 is selectively sized to store several gallons of freshwater. Third storage unit 40 is filled to a predetermined capacity with a colorant 64. In the exemplary embodiment, colorant 64 is one of a known colorant dyes that can be utilized change the color of hydrated firefighting composition 12 from a first, or uncolored shade, to a second or colorized shade.

System 300 is configurable to produce a fully hydrated firefighting composition 12 that includes a predetermined percentage of firefighting gel concentrate 60, a predetermined percentage of hydrating fluid 62, and a predetermined percentage of colorant 64. Accordingly, to operate system 300, the operator inputs a desired firefighting gel concentration setting into computing module 310. For example, the operator may select a gel concentration that, in the exemplary embodiment, is between approximately 0.5% and approximately 3.0% of the total volume of firefighting composition 12 produced by system 300. Additionally, the operator may select a colorant 64 concentration that, in the exemplary embodiment, is between approximately 0.1% and approximately 1.0% of the total volume of firefighting composition 12 produced by system 300.

After the selected concentrations of gel concentrate 60 and colorant 64 have been entered, system 300 is initialized to produce hydrated firefighting composition 12. More specifically, second pump 80 is initialized to discharge hydrating fluid 62 from storage unit 30 into manifold 50. In the exemplary embodiment, second pump 80 is configured to discharge hydrating fluid 62 into manifold 50 at approximately four hundred gallons per minute. Computing module 310 receives inputs from pressure sensor 160, flow sensor 162, and temperature sensor 164. Computing module 310 then energizes pump 90 to facilitate colorant 64 into manifold 50 based on either the temperature, pressure, or flowrate of hydrating fluid 62 being discharged through manifold 50. For example, if second pump 80 is discharging approximately four-hundred GPM through manifold 50, and an operator has selected a fully hydrated firefighting composition 12 that includes approximately 1.0% colorant 64 per volume produced, computing module 310 will energize pump 90 such that pump 90 discharges approximately four GPM of colorant 64 into manifold 50. Additionally, if the operator has selected a fully hydrated firefighting composition 12 that includes approximately 3.0% gel concentrate 60 per volume of fully hydrated firefighting composition 12 produced, computing module 310 will energize pump 70 such that pump 70 discharges approximately twelve GPM of gel concentrate 60 into manifold 50.

As explained previously herein, gel concentrate 60, hydrating fluid 62, and colorant 64 initially form a heterogeneous composition within manifold 50. The heterogeneous composition is then channeled through manifold 50 and into static mixer 52 wherein the heterogeneous composition is mixed and/or blended to form fully hydrated firefighting composition 12. More specifically, static mixer 52 facilitates blending or mixing the heterogeneous composition without storage within static mixer 52. Thus, the heterogeneous composition is channeled through static mixer input 114, mixed within static mixer 52 without storage, and discharged from static mixer discharge 116 as a fully blended, homogeneous firefighting composition 12 that is also fully hydrated when discharged from static mixer 52.

Described herein is a method and systems that may be utilized to produce a fully hydrated firefighting composition that does not require storage prior to being utilized to fight fires. The systems described herein are configured to receive an operator input indicative of the quantity of firefighting composition to produce, the percentage of gel concentrate within the firefighting composition, and the percentage of colorant within the firefighting composition. The computing module automatically, operates a plurality of pumping modules to channel the heterogeneous solution formed by the hydrating fluid, the gel concentrate, and the colorant to a mixing station. The mixing station is then utilized to fully mix the heterogeneous composition to produce a fully hydrated or homogeneous firefighting composition.

More specifically, a pump supplies freshwater to a manifold. Detecting the freshwater flowstream, a microprocessor causes a colorant to be injected into the flow. As the flow continues, a second microprocessor again measures the flow and proportionally causes a chosen amount of gel concentrate to be injected into the stream. The heterogeneous gel concentrate and water solution move downstream and enter the multiple stage static or dynamic mixer wherein the heterogeneous solution is combined to form a homogeneous fully hydrated gel solution of the requested color, wherein the viscosity does not substantially vary by more than 25% within a twenty-four hour period following discharge of the gel composition from the system.

Moreover, by utilizing a microprocessor to control the injection rates for both color and gel concentrate, the blending process will allow Long Term Gel Retardant to be produced in various viscosities and colors as desired by the end-user in a single step, instant, and continuous process without any storage of the product within the static mixer. Accordingly, the storage requirement for known firefighting compositions is eliminated, and thus creating retardant inventory that may not be needed is eliminated by eliminating the storage requirement that is required in a two-step process.

A hydro-mechanical system may also be used. For example, water pressure/flow in the pipes can be used to cause a proportioner to actuate a piston to inject concentrate into the flow of the water.

While the invention has been described in terms of various. specific embodiments, those skilled in the art will recognize that the invention can be practiced with modification within the spirit and scope of the claims.

What is claimed is:

1. A method of producing a hydrated firefighting composition, comprising:
providing a fire fighting gel concentrate at a predetermined gel flow rate;
providing a hydrating liquid at a predetermined liquid flow rate;
controlling at least one of the gel flow rate and the liquid flow rate based on the other of the gel flow rate and the liquid flow rate; and
combining the firefighting gel concentrate and the hydrated liquid to produce a hydrated firefighting composition.

2. The method of claim 1, wherein the controlling includes adjusting the gel concentrate flow rate based on the hydrating liquid flow rate.

3. The method of claim 1, wherein the controlling includes adjusting the hydrating liquid flow rate based on the gel concentrate flow rate.

4. The method of claim 1, wherein the combining produces a fully hydrated homogeneous firefighting composition without storage.

5. The method of claim 1, wherein, prior to the combining, the hydrating liquid and the gel concentrate form a heterogeneous solution, and, following the combining, form a homogeneous solution.

6. The method of claim 1, wherein the combining is performed at a blending stage having an inlet and a discharge, the hydrating liquid and the gel concentrate entering the blending stage at the inlet as a heterogeneous solution and continuously flowing from the inlet to the discharge without storage in the blending stage, the hydrating liquid and the gel concentrate exiting the discharge as a homogeneous solution without storage in the blending stage.

7. The method of claim 1, wherein the combining includes adjusting one of the hydrating liquid and the gel concentrate flow rates to maintain the gel concentrate flow rate at between 0.0001% and 10.0% of the hydrating liquid flow rate.

8. The method of claim 1, wherein the providing includes providing a polymer fire fighting gel concentrate at a predetermined gel flow rate.

9. The method of claim 1 further comprising:
providing a colorant at a predetermined colorant flow rate; and
combining the firefighting gel concentrate, the hydrated liquid, and the colorant to produce a hydrated firefighting composition.

10. The method of claim 1, wherein the combining is substantially completed within no more than twenty-four hours following a point in time at which the firefighting gel concentrate and the hydrating liquid are initially combined.

11. The method of claim 1, wherein the combining includes combining the firefighting gel concentrate and the hydrated liquid to produce a hydrated firefighting composition that has a viscosity that does not vary by more than 15 percent within six hours of the firefighting gel concentrate being initially combined with the hydrating liquid.

12. A fully hydrated homogeneous firefighting composition prepared in accordance with the method of claim 1, the firefighting composition having a viscosity that does not vary more than 20 percent within twelve hours of the firefighting gel concentrate being initially combined with the hydrating liquid.

13. A fully hydrated homogeneous firefighting composition prepared in accordance with the method of claim 1, the firefighting composition having a viscosity that does not vary more than 25 percent within twenty-four hours of the firefighting gel concentrate being initially combined with the hydrating liquid.

14. A fully hydrated homogeneous firefighting composition prepared in accordance with the method of claim 1, the firefighting composition having a viscosity that does not vary more than 15 percent within six hours of the firefighting gel concentrate being initially combined with the hydrating liquid.

15. A system for producing a hydrated firefighting composition, comprising:
inlets that are configured to be combined to storage units that are configured to separately contain a fire fighting gel and a hydrated liquid;
a pumping module for conveying the firefighting gel at a predetermined gel flow rate and for conveying the hydrating liquid at a predetermined liquid flow rate, the pumping module controlling at least one of the gel flow rate and the liquid flow rate based on the other of the gel flow rate and the hydrating liquid flow rate; and
a mixing station combining the firefighting gel and hydrated liquid to produce a hydrated firefighting composition.

16. The system of claim 15, wherein the mixing station includes at least one of a static mixer and a dynamic mixer each having an inlet and a discharge, the inlet receiving a heterogeneous solution formed from the gel and liquid, the mixer continuously conveying the heterogeneous solution from the inlet to the discharge without storage therein.

17. The system of claim 15, wherein the mixing station includes a mixer having an inlet and a discharge, the mixing station including baffles through which the gel and liquid are passed and form a homogeneous solution when discharged from the baffles.

18. The system of claim 15, wherein the mixing station includes a static mixer having an inlet and a discharge, the mixing station including baffles through which the gel and liquid are passed to form a fully hydrated solution there from.

19. The system of claim 15, further comprising a flow detector monitoring the liquid flow rate, the pumping module adjusting the gel flow rate based on an output of the flow detector or a mass flow rate of the liquid.

20. The system of claim 15, further comprising a controller joined to the pumping module, the controller identifying the liquid flow rate and based thereon, adjusting the gel flow rate.

21. The system of claim 15, further comprising a controller joined to the pumping module, the controller identifying the liquid flow temperature and based thereon, adjusting the gel flow rate.

22. The system of claim 15 further comprising a computing module coupled to the pumping module, the computing module programmed to convey the firefighting gel at a predetermined gel flow rate and convey the hydrating liquid at a predetermined liquid flow rate to the mixing station.

23. The system of claim 15, further comprising an input configured to receive a colorant, the pumping module conveying the colorant at a predetermined colorant flow rate, said mixing station combining the firefighting gel, the hydrated liquid, and the colorant to produce a colored hydrated firefighting composition.

24. The system of claim 15, wherein the mixing station combines the firefighting gel and hydrated liquid to produce a hydrated firefighting composition within no more than twenty-four hours following a point in time at which the firefighting gel concentrate and the hydrating liquid are initially combined.

25. The system of claim 15, wherein the mixing station combines the firefighting gel and hydrated liquid to produce a hydrated firefighting composition that has a viscosity that does not vary by more than 15 percent within six hours of the firefighting gel concentrate being initially combined with the hydrating liquid.

26. The system of claim 15, wherein the mixing station combines the firefighting gel and hydrated liquid to produce a hydrated firefighting composition that has a viscosity that does not vary more than 20 percent within twelve hours of the firefighting gel concentrate being initially combined with the hydrating liquid.

27. The system of claim 15, wherein the mixing station combines the firefighting gel and hydrated liquid to produce a hydrated firefighting composition having a viscosity that does not vary more than 25 percent within twenty-four hours of the firefighting gel concentrate being initially combined with the hydrating liquid.

28. A system in accordance with claim 15, further comprising a first computing module for controlling the gel flow rate, a second computing module for controlling the liquid flow rate, and a third computing module for controlling a colorant flow rate.

29. A system in accordance with claim 15, further comprising a portable vehicle, said storage units, said pumping module, and said mixing station coupled to said portable vehicle.

30. The method of claim 1, wherein the combining includes adjusting one of the hydrating liquid and the gel concentrate flow rates to maintain the gel concentrate flow rate at between 0.5% and 3.0% of the hydrating liquid flow rate.
